(19) United States
(12) Patent Application Publication
(10) Pub. No.: US 2015/0287153 A1
(43) Pub. Date: Oct. 8, 2015

(54) Management of rights and royalties associated with a media

(71) Applicants: Kalyan C. Kankanala, Bangalore (IN); Sharada Kalamadi, Mumbai (IN); Somashekar Ramakrishna, Bangalore (IN); Nitin Nair, Bangalore (IN)

(72) Inventors: Kalyan C. Kankanala, Bangalore (IN); Sharada Kalamadi, Mumbai (IN); Somashekar Ramakrishna, Bangalore (IN); Nitin Nair, Bangalore (IN)

(21) Appl. No.: 14/679,059

(22) Filed: Apr. 6, 2015

(30) Foreign Application Priority Data
Apr. 4, 2014 (IN) 1797/CHE/2014

(51) Int. Cl. G06Q 50/18

(52) U.S. Cl. CPC G06Q 50/184

(57) ABSTRACT

Management of rights and royalties associated with a media. Embodiments herein disclose a method and system for managing rights associated with a media among at least one contributor to the media Embodiments herein disclose a method and system for managing rights associated with a media by an entity that controls the rights to the media Embodiments herein disclose a method and system for managing royalty for a media, based on the contributors and their designated share of the royalty.

### TECHNICAL FIELD

Embodiments herein relate to management of a media and more particularly to managing rights associated with a media and sharing of royalty among the rights holders arising out of the media.

### BACKGROUND

Currently, creation of a media (wherein the media can comprise of at least one of audio, video, text and so on) involves contributions from a plurality of entities. These entities can be persons or organizations. For example, consider a sound recording. Creation of a sound recording will involve at least one lyricist (who writes the lyrics present in the sound recording), at least one music director (who writes the music), at least one singer, at least one musician (who plays the instruments involved in the recording) and at least one music producer (who records the sound recording based on the contributions from the lyricist(s), music director(s), musician(s) and singer(s)). Each of these contributors can have rights assigned to them based on their contributions.

Managing the rights assigned to each of these contributors is an onerous task. These can involve determining the rights to be associated with each of the contributors, the percentage of revenue to be shared with the contributors (if the revenue is to be shared), membership of societies (copyright societies and so on) and so on.

In some jurisdictions, there are laws, which delineate the rights of the contributors and the revenue to be shared with each of these contributors. However, these are broad rights and do not provide a means to determine the exact percentage of royalty sharing, the exact nature of the rights to be assigned and so on.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a rights manager, according to embodiments as disclosed herein; and

FIG. 2 depicts the modules of the rights manager, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

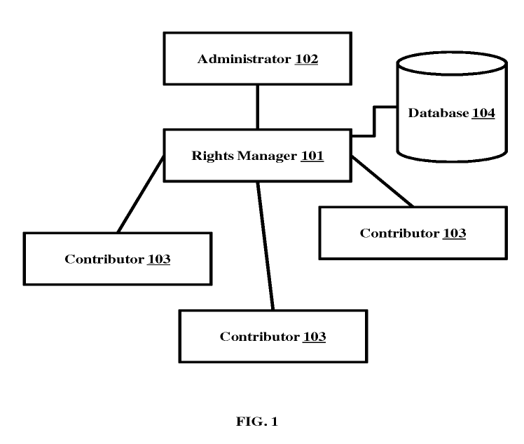

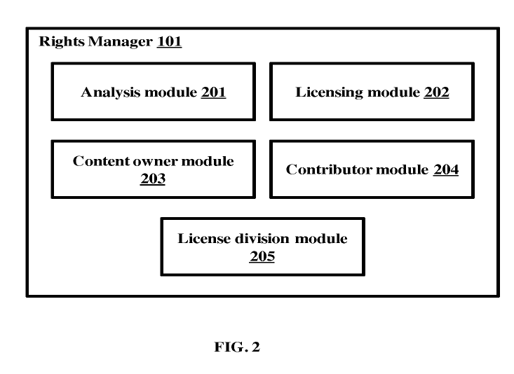

The embodiments herein achieve a method and system for managing rights associated with a media and sharing of royalty among the rights holders arising out of the media. Referring now to the drawings, and more particularly to FIGS. 1 and 2, where similar reference characters denote corresponding features consistently throughout the figures, there is shown preferred embodiments.

Embodiments herein provide a method and system for managing rights associated with a media among at least one contributor to the media. Embodiments herein provide a method and system for managing rights associated with a media by an entity that controls the rights to the media. Embodiments herein provide a method and system for managing royalty for a media, based on the contributors and their designated share of the royalty.

FIG. 1 depicts a rights manager, according to embodiments as disclosed herein. The figure depicts a rights manager 101 is connected to at least one administrator 102 and at least one contributor 103. The rights manager 101 can be connected to at least one database 104. The administrator 102 can be a person and/or an entity authorized to access the rights associated with a media (such as a producer, a music label and so on), assign rights associated with a media to at least one contributor 103, license the media out based on the rights, manage the royalties arising out of licensing the media and distribute the royalties among the contributors based on their contributions. The administrator 102 can be the content owner. The administrator 102 can be an entity distinct from the content owner. The administrator 102 can also consider the laws under which the media has been created, while assigning the rights and distributing the royalty. The contributor 103 can be any person and/or entity that have contributed to the media. The database 104 can comprise of one or more databases. The database 104 can be co-located with the rights manager 101. The database 104 can be located remotely from the rights manager 101. At least one portion of the database 104 can be on the cloud. The database 104 can comprise of information provided by the administrator 102, the contributor 103, the content owner, and other sources. The database 104 can comprise of information related to at least one law of the jurisdiction(s), which governs the agreement between the contributor and the content owner. The database 104 can also comprise of information such as the list of locations to be monitored (such as websites, radio stations, television channels, online streaming sites/applications, and so on) and so on. The list of locations can be locations, which are using/playing/broadcasting the media. The list of locations can be locations, which contain information related to the laws (legal provisions and so on), the agreements, government directions/notices, and so on.

The media can be any creative content/components of any creative nature from music, literary, cinematographic, photographic, or sound recording content to creative content of any other form, which can comprise of a single media or as a plurality of components, which together form the media. Examples of media can be sound recordings (such as songs, instrumental pieces and so on), cinematographic films (such as films, documentaries and so on) and so on.

For example, consider a sound recording. The contributors for a sound recording can comprise of at least one lyricist (who writes the lyrics present in the sound recording), at least one music director (who writes the music), at least one singer, at least one musician (who plays the instruments involved in the recording) and at least one music producer (who records the sound recording based on the contributions from the lyricist(s), music director(s), musician(s) and singer(s)).

In another example, consider a cinematographic film. The contributors for a film can comprise of at least one producer, at least one line producer, at least one director, at least one assistant director, at least one art director, at least one writer, at least one story writer/script writer, at least one script supervisor, at least one dialogue writer, at least one song lyricist, at least one music composer, at least one singer, at least one background music composer, actors (lead actors, side actors and so on), at least one photography director, at least one dancer, at least one choreographer, at least one costume director, set creators, at least one in-film branding and so on.

The rights manager 101 can capture relationships with contributors involved in creation of the media. The rights and applicable royalty sharing for each contributor will be determined based on a plurality of factors such as the contracts with the contributors and the content owners, legal mandates (if any) with respect to the relationship; and society membership of the contributor (if applicable). The rights manager 101 can capture relationships using at least one of an automatic means or a manual means (wherein it can be provided by the administrator).

The rights manager 101 can further analyze licenses that are given on a work or group of works. For example, the script, lyrics, musical composition, cinematographic work, sound recording, and so on, for a film will be considered as one work for certain licenses. The rights manager 101 can capture information such as licenses granted for each work; licenses granted for a catalogue (such as all songs in one catalogue, select songs in a catalogue and so on, wherein catalogue refers to a group of media, all works of a single work will be categorized as one group, and licenses of all the works will be captured. The rights manager 101 can capture the data about licenses automatically and/or manually.

The rights manager 101 can help the content owner and/or administrator in setting licensing revenue targets with respect to the work(s), monitoring these targets, and complying with law with respect to royalty sharing based on the targets.

The rights manager 101 can help the contributors to track their engagements with the content owners, how many works they have created, how much and when their royalties are due, how much is paid and how much is pending, and so on.

The rights manager 101 can also show data with respect to license sharing for works, licenses, revenues and targets for each work, content owner, contributor and so on.

The rights manager 101 can be configured for creating a rights chart. The rights manager 101 can initially create the stakeholders and defines a role for each of the stakeholders. The administrator 102 can enter the stakeholders and their role manually. The stake holders and their roles can be created automatically, based on a plurality of factors comprising of type of media, prior entries made by the administrator 102 and so on. The rights manager 101 can select at least one work against the role. The work that can be selected can be pre-defined by the administrator 102. The administrator 102 can enter the work manually. The rights manager 101 can further define a relationship between the stakeholders, in terms of the rights.

The rights manager 101 can capture the nature of right transfer. The rights can be transferred through contracts, and so against each work/performance. The rights manager 101 enables the transfer agreement/document to be uploaded to the rights manager 101 or any other accessible location on the network where the rights manager 101 is located, the cloud or any other equivalent location. The rights manager 101 can automatically capture the transfer information from the agreement/document. The rights manager 101 can also enable the administrator 102 to enter the transfer information manually. The transfers can be broadly placed under three categories. The transfer can be a work for hire, where ownership directly vests with administrator 102. The transfer can be an assignment, where the contributors 103 transfer ownership to the administrator. The transfer can be at least one of a complete transfer or a partial transfer; a conditional transfer or an unconditional transfer and so on. The transfer can also be linked with a onetime royalty or a continuing royalty. The transfer can be a license, which provides authorization to exercise rights of the contributor by the administrator 102. The license can be at least one of a complete transfer or a partial transfer; a conditional transfer or an unconditional transfer and so on. The license can also be linked with a onetime royalty or a continuing royalty.

The rights manager 101 can capture the transaction, and specifics of the transaction such as work for hire (wherein the ownership rests with the administrator); assignment (what rights are assigned, is there a term limitation for the rights assignment, for what purpose have the rights been assigned, are there any conditions for usage, nature of royalty (one time/continuing) and so on); license (what rights are licensed, is there a term limitation, for what purpose have the rights been licensed, are there any conditions for usage, nature of royalty (one time/continuing)) and so on.

The rights chart can comprise of nature of transfers, royalty conditions, terms, and so on for each entity/person related to the media. The rights chart can also provide the nature of transfers (exclusive/non-exclusive), royalties, available rights (rights which have not yet been assigned) and so on.

The rights manager 101 can consider the rights of the territory, where each of the agreements have been executed. The rights manager 101 can check if the terms of the agreement are in line with the laws of the territory. On the rights manager 101 detecting any issues with respect to the laws, the rights manager 101 can raise an alert to the administrator 102.

The rights manager 101 can further manage the exploitation of the media. The rights manager 101 can list the nature of exploitation, which can be divided into rights (reproduction, distribution, performance, adaptation and so on), mode/manner of exploitation (physical, digital, live and so on) and platforms (radio, television, internet, mobile and so on). The rights manager 101 can calculate how each work is exploited, and who is the assignee/licensee, and royalties from such exploitation. The rights manager 101 can calculate this based on at least one of agreements between the contributors and the administrator, the license between the contributors and the administrator, the rights chart or any other document which delineates the nature of transfers, royalty conditions, terms and so on for each entity/person related to the media.

The rights manager 101 further defines the share of royalty receivable by each contributor and/or administrator with regards to the exploitation of the media. The rights manager 101 can define the royalty receivable based on factors comprising of an initial agreement between the contributors and the administrator; royalty sharing mandate under the laws of the territory for this type of media; total royalty earned from a work, and percentage due to each contributor and/or administrator. The rights manager 101 can generate reports to show the exact royalty sharing and distribution among the contributors and/or administrators. The rights manager 101 can also consider the distribution of royalty through a statutory license. The rights manager 101 can also consider the existence of a society for a specific media, wherein the royalty for that type of media has to be mandatorily collected by that society.

FIG. 2 depicts the modules of the rights manager, according to embodiments as disclosed herein. The rights manager 101 can comprise of an analysis module 201, a licensing module 202, a content owner module 203, a contributor module 204, and a license division module 205.

The analysis module 201 can capture relationships with contributors involved in creation of the media. The analysis module 201 can determine the rights and applicable royalty sharing for each contributor based on a plurality of factors such as the contracts with the contributors and the content owners, legal mandates (if any) with respect to the relationship; and society membership of the contributor (if applicable). The analysis module 201 can capture relationships using at least one of an automatic means or a manual means (wherein it can be provided by the administrator).

The analysis module 201 can capture the plurality of factors manually. The analysis module 201 can capture the plurality of factors automatically from locations (as specified by the administrator). The analysis module 201 can also analyze documents uploaded (such as agreements covering the type of work, the license sharing means, the number of contributors and so on from the agreements between the contributors and the content owners). The analysis module 201 can also obtain these factors from legal sources, which can be entered manually. The analysis module 201 can automatically derive these factors from analysis of laws/acts/rules, statutes, government directions, and so on.

Based on the plurality of factors, the analysis module 201 can derive the rights acquisition status (nature of relationship) between each contributor and the content owner. In an example, the agreement can be for a work for hire, assignment, license or any other equivalent means. The analysis module 201 can derive the rights acquisition status based on an analysis of terms of each agreement. In an embodiment herein, the analysis module 201 can scan the agreement for specific keyword(s)/phrases to determine the rights acquisition status. In an embodiment herein, the analysis module 201 can be provided by the rights acquisition status manually by the administrator.

The analysis module 201 further checks if the agreement is valid by checking if the agreement violates at least one section and/or clause within the law. This can be performed in an automatic manner. If the analysis module 201 determines that the agreement is invalid, the analysis module 201 can automatically highlight invalid contracts. In an example, under the Indian Copyright law, works for hire contracts are prohibited for authors (wherein authors include lyricists, script writers and so on) and music composers.

The analysis module 201 can capture a plurality of factors related to the agreement such as the term of each agreement, restrictions of use, and so on. The analysis module 201 can perform this in an automatic manner and/or manually.

The analysis module 201 can depict the nature of relationship (work for hire, assignment, license, and so), term and rights that can be used by an acquirer of rights to the works, royalty paid by the acquirer; and so on.

The analysis module 201 can depict the eligibility for future royalty sharing. The analysis module 201 can determine this based on contract and legal provisions (based on the agreement and government laws/rules/acts and so on). For example, authors of literary and musical works incorporated in films are eligible for royalty share, and the analysis module 201 can determine that they are eligible for royalty, and forms of exploitation for which they are eligible; and so on.

The analysis module 201 can determine the total royalty for which contributors and content owners will be eligible at specified time intervals. The analysis module 201 can determine the royalty, which each contributor and content owner will be eligible at specified time intervals. The analysis module 201 can also determine based on revenues received from film, sound recording, lyrics, musical composition, and so on, on how much royalty the contributors and content owners will get in revenues (in total and on a per contributor/content owner basis).

The licensing module 202 can further analyze licenses that are given on a work or group of works. For example, the script, lyrics, musical composition, cinematographic work, sound recording, and so on, for a film will be considered as one work for certain licenses. The licensing module 202 can capture information such as licenses granted for each work; licenses granted for a catalogue (such as all songs in one catalogue, select songs in a catalogue and so on, wherein catalogue refers to a group of media, all works of a single work will be categorized as one group, and licenses of all the works will be captured. The licensing module 202 can capture the data about licenses automatically and/or manually.

The licensing module 202 can provide reports on rights granted over a work, or group of works, and rights available. The licensing module 202 can provide this information in the form of a rights management chart. The rights management chart can also show which rights are yet to be licensed and opportunities for licensing.

The licensing module 202 can track the license terms and deadlines. This can be in terms of agreements lapsed with the acquirer, the lapsing of the copyright terms, the royalty terms and any other term in the form of time. The licensing module 202 can provide an alert to the administrator and/or the contributor.

The licensing module 202 can generate license fee and royalty reports. The reports will show revenues received for each work, for group of works, for catalogues, for a specific type of licensing—radio, television, theatrical, digital, mobile, internet, and so on, for all works and group wise. The licensing module 202 can receive the information required for calculating license fee and royalty manually. The licensing module 202 can derive the information required for calculating license fee and royalty from the at least one location.

The licensing module 202 can also perform prediction of licensing revenues for the future based on current revenues, new opportunities, inflation, and other equations based on historical data and performance (available in the database 104). The licensing module 202 can receive the information required for predicting licensing revenues manually. The licensing module 202 can derive the information required for predicting licensing revenues from the at least one location.

The licensing module 202 can also indicate if there is a statutory license applicable for a particular type of license. For example, the Indian copyright law grants statutory licenses for television and radio broadcasting, making version recordings, and so on if used by disabled persons.

The licensing module 202 can also capture any royalty set by a third party such as a society or government entity (such as a Copyright Board and so on) on particular mode of licensing/exploitation. The licensing module 202 can also capture data from rate cards of copyright societies to calculate license fee, royalty payable, and royalty if applicable. The data about rate cards of copyright board and societies may be manually entered, or automatically fetched by software from the at least one location.

The content owner module 203 can help the content owner and/or administrator in setting licensing revenue targets with respect to the work(s), monitoring these targets, and complying with law with respect to royalty sharing based on the targets. The content owner module 203 can enable the content owner to see reports of total royalty from works, which work is doing well, which types of licenses are getting more revenues, which types of licenses are not adding much value and so on. The content owner module 203 can also predict future license revenues based on past performance, works to be added in the future and so on.

The content owner module 203 can determine revenue targets for each division, movie, type of market, and so on. The content owner module 203 can enable the content owner to track progress in a real-time manner.

The content owner module 203 can enable the content owner to see how much royalty is due to which contributor in a specific time period (say a financial year, calendar year and so on), whether the royalty has been paid or not, the contributors whose works are doing better than others and so on. The content owner can use this data to enable future engagements, and provide data for negotiating payments and so on.

The content owner module 203 can predict licensing related information such as licensing revenues for a specific period of time (for example, for a year, for three years and so on), royalty sharing obligation for a specific period of time (for example, for a year, for three years and so on), etc.

The contributor module 204 can help the contributors to track their engagements with the content owners, how many works they have created, how much and when their royalties are due, how much is paid and how much is pending, and so on.

The license division module 205 can show data with respect to license sharing for works, licenses, revenues and targets for each work, content owner, contributor and so on.

The above mentioned modules can enable the administrator, the content owner and/or the contributors to access the above information in a real-time manner, provided they have the rights to access the information. The above mentioned modules can enable the administrator, the content owner and/or the contributors to access the above information at any point in time (including historical data) as the rights manager 101 stores the above information in the database 104, provided they have the rights to access the information.

Embodiments herein use the terms ‘media’, ‘catalogue’ and ‘work’ interchangeably to denote a single or group of creative contents/components of any creative nature from music, literary, cinematographic, photographic, or sound recording content to creative content of any other form, which can comprise of a single media or as a plurality of components, which together form the media.

Embodiments herein use the terms ‘agreement’ and ‘contract’ interchangeably to denote an agreement between at least one contributor and the content owner. The agreement can also between the contributors.

Embodiments herein use specific examples, which considers the laws in India; however, it may be obvious to a person of ordinary skill in the art to extend the embodiments as disclosed herein to any jurisdiction which has laws/rules/acts governing the sharing of royalty between contributors and content owners.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for managing rights associated with at least one media, said method comprising of
determining a relationship between at least one contributor and a content owner of said at least one media by a rights manager, wherein at least one agreement exists between said at least one contributor and said content owner; and
performing analysis of at least one license by said rights manager, based on said at least one agreement and said determined relationship.

2. The method, as claimed in claim 1, wherein said method further comprises of said rights manager determining if said agreement is an invalid agreement.

3. The method, as claimed in claim 1, wherein said relationship comprises of type of relationship, terms and rights acquired by an acquirer of said at least one media, and royalty paid for said at least one media.

4. The method, as claimed in claim 1, wherein determining said relationship further comprises of said rights manager determining if said at least one contributor is eligible for royalty sharing.

5. The method, as claimed in claim 1, wherein determining said relationship further comprises of said rights manager determining royalty to paid to each of said at least one contributor and time intervals at which royalty is to be pain to each of said at least one contributor.

6. The method, as claimed in claim 1, wherein performing analysis of said at least one license comprises of said rights manager generating a rights management chart, wherein said rights management chart comprises of reports on rights granted over said at least one media, rights not yet granted over said at least one media, rights not yet licensed over said at least one media, and opportunities for licensing.

7. The method, as claimed in claim 1, wherein performing analysis of said at least one license comprises of at least one of
tracking license terms and providing at least one alert about a deadline for said license terms by said rights manager
generating a license fee and royalty report by said rights manager;
predicting future licensing revenues by said rights manager; and
indicating a requirement of a statutory license by said rights manager.

8. The method, as claimed in claim 1, wherein performing analysis of said at least one license comprises of said rights manager capturing royalty rates determined by a third party.

9. The method, as claimed in claim 1, wherein said method further comprises of said rights manager enabling said content owner to set licensing revenue targets, monitoring said licensing revenue targets, determining royalty to be paid to each of said at least one contributor, predicting licensing revenues, and ensuring compliance with royalty sharing requirements.

10. The method, as claimed in claim 1, wherein said method further comprises of said rights manager enabling said at least one contributor to monitor said at least one media, royalties due to said at least one contributor, and when said royalties are due to said at least one contributor.

11. A rights manager for managing rights associated with at least one media, said rights manager configured for
determining a relationship between at least one contributor and a content owner of said at least one media, wherein at least one agreement exists between said at least one contributor and said content owner; and
performing analysis of at least one license, based on said at least one agreement and said determined relationship.

12. The rights manager, as claimed in claim 11, wherein said rights manager is further configured for determining if said agreement is an invalid agreement.

13. The rights manager, as claimed in claim 11, wherein said relationship comprises of type of relationship, terms and rights acquired by an acquirer of said at least one media, and royalty paid for said at least one media.

14. The rights manager, as claimed in claim 11, wherein rights manager is configured for determining said relationship by checking if said at least one contributor is eligible for royalty sharing.

15. The rights manager, as claimed in claim 11, wherein rights manager is configured for determining said relationship by determining royalty to paid to each of said at least one contributor and time intervals at which royalty is to be pain to each of said at least one contributor.

16. The rights manager, as claimed in claim 11, wherein rights manager is configured for performing analysis of said at least one license by generating a rights management chart, wherein said rights management chart comprises of reports on rights granted over said at least one media, rights not yet granted over said at least one media, rights not yet licensed over said at least one media, and opportunities for licensing.

17. The rights manager, as claimed in claim 11, wherein rights manager is configured for performing analysis of said at least one license by
tracking license terms and providing at least one alert about a deadline for said license terms by said rights manager
generating a license fee and royalty report by said rights manager;
predicting future licensing revenues by said rights manager; and
indicating a requirement of a statutory license by said rights manager.

18. The rights manager, as claimed in claim 11, wherein rights manager is configured for performing analysis of said at least one license by capturing royalty rates determined by a third party.

19. The rights manager, as claimed in claim 11, wherein said rights manager is configured for enabling said content owner to set licensing revenue targets, monitoring said licensing revenue targets, determining royalty to be paid to each of said at least one contributor, predicting licensing revenues, and ensuring compliance with royalty sharing requirements.

20. The rights manager, as claimed in claim 1, wherein said rights manager is configured for enabling said at least one contributor to monitor said at least one media, royalties due to said at least one contributor, and when said royalties are due to said at least one contributor.
